(19) United States
(12) Patent Application Publication
(10) Pub. No.: US 2020/0010007 A1
(43) Pub. Date: Jan. 9, 2020

(54) RACE TRACK TRAILER

(71) Applicant: Aaron Sanders, Shakopee, MN (US)

(72) Inventor: Aaron Sanders, Shakopee, MN (US)

(21) Appl. No.: 16/299,545

(22) Filed: Mar. 12, 2019

Related U.S. Application Data
(60) Provisional application No. 62/695,258, filed on Jul. 9, 2018.

(51) Int. Cl. B60P 3/00; B62D 63/06; B62D 63/08; B60J 5/04; E05C 17/36; A63H 18/02; A63H 30/00

(52) U.S. Cl. CPC B60P 3/00; B62D 63/068; B62D 63/08; A63H 30/00; E05C 17/36; A63H 18/02; B60J 5/04

(57) ABSTRACT

The present invention provides a race track trailer system for transporting and using a race track for use with one or more radio-controlled vehicles. The race track trailer system includes a trailer and a race track for use with one or more radio-controlled vehicles.

### RELATED APPLICATIONS

This application claims priority to U.S. Provisional Patent Application Ser. No. 62/695,258 filed Jul. 9, 2018, and to U.S. Provisional Patent Application Ser. No. 62/641,461 filed Mar. 12, 2018, both of which are hereby incorporated by reference in their entirety for all purposes.

### BACKGROUND OF THE INVENTION

Racing radio-controlled toy cars on race tracks provides entertainment for children and adults. Race track systems typically include many sections that must be connected together to form a closed loop upon which the radio-controlled cars are raced. However, these are difficult and time consuming to transport because they must be dissembled at one site and reassembled at another site.

What is needed is a race track for use with radio-controlled vehicles that can be easily transported from site to site and can be readily deployed.

### SUMMARY OF THE INVENTION

The present invention provides a race track trailer system for transporting and using a race track for use with one or more radio-controlled vehicles. The race track trailer system includes a trailer and a race track for use with one or more radio-controlled vehicles.

The race track trailer system is designed to be easily assembled, used, disassembled, and transported. Further, the race track can be easily assembled into multiple orientations and configurations.

The present invention provides a race track trailer system for transporting and using a race track for use with one or more radio-controlled vehicles. The race track trailer system includes: a trailer having a first surface, a second surface, and a door having a first surface and a second surface, wherein the door is operatively connected to the trailer; a race track for use with one or more radio-controlled vehicles, wherein the race track includes: a first race track section having a first surface and a second surface having one or more first lanes, wherein the first race track section is operatively connected to the first surface of the trailer; a second race track section having a first surface with one or more second lanes and a second surface, wherein the second race track section is operatively connected to the first race track section; a third race track section having a first surface and a second surface with one or more third lanes, wherein the third race track section is operatively connected to the first surface of the door; one or more support members each independently having a proximal end operatively connected to the trailer and a distal end each independently operatively connected to the door, and when the race track is being used, the door of the trailer rotates from a closed position when the race track is being transported to an open position, and the one or more support members are each independently extended.

In one embodiment, the door is operatively connected to the trailer with one or more first hinges, one or more first support members, or a combination thereof. In one embodiment, the second race track section rotates from the first race track section to be operatively connected with the third race track section when the door of the trailer is in an open position and the one or more support members are each independently extended. In one embodiment, the race track has a predetermined track layout forming a closed loop including the one or more first lanes, the one or more second lanes, and the one or more third lanes in which the one or more radio-controlled vehicles can travel on when the door of the trailer is an open position, the one or more support members are each independently extended, the second race track section is operatively connected to the third race track section, and wherein the closed loop is on the second surface of the first race track section, the first surface of the second race track section, and the second surface of the third race track section.

In one embodiment, the first surface of the first race track section is operatively connected to the first surface of the trailer. In one embodiment, the first surface of the second race track section is operatively connected to the second surface of first race track section with one or more second hinges. In one embodiment, the one or more support members each independently include one or more chains, one or more ropes, one or more cables, or a combination thereof. In one embodiment, the race track trailer system further includes one or more radio-controllers that each independently control the one or more radio-controlled vehicles.

The present invention provides a race track trailer system for transporting and using a race track for use with one or more radio-controlled vehicles. The race track trailer system includes: a trailer having a first surface, a second surface, and a door having a first surface and a second surface, wherein the door is operatively connected to the trailer; a race track for use with one or more radio-controlled vehicles, wherein the race track includes: a first race track section having a first surface and a second surface having one or more first lanes, wherein the first race track section is operatively connected to the first surface of the trailer; a second race track section having a first surface with one or more second lanes and a second surface, wherein the second race track section is operatively connected to the first race track section; a third race track section having a first surface and a second surface with one or more third lanes, wherein the third race track section is operatively connected to one or more slide members that are each independently operatively connected to the first surface of the door; one or more support members each independently having a proximal end operatively connected to the trailer and a distal end each independently operatively connected to the door, when the race track is being used, the door of the trailer rotates from a closed position when the race track is being transported to an open position, the one or more slide members are each independently extended, and the one or more support members are each independently extended, and wherein the door is operatively connected to the trailer with one or more first hinges, one or more first support members, or a combination thereof.

In one embodiment, the second race track section rotates from the first race track section to be operatively connected with the third race track section when the door of the trailer is in an open position, the one or more slide members are each independently extended, and the one or more support members are each independently extended. In one embodiment, the race track has a predetermined track layout forming a closed loop comprising the one or more first lanes, the one or more second lanes, and the one or more third lanes in which the one or more radio-controlled vehicles can travel on when the door of the trailer is an open position, the one or more slide members are each independently extended, the one or more support members are each independently extended, the second race track section is operatively connected to the third race track section, and wherein the closed loop is on the second surface of the first race track section, the first surface of the second race track section, and the second surface of the third race track section.

In one embodiment, the first surface of the first race track section is operatively connected to the first surface of the trailer. In one embodiment, the first surface of the second race track section is operatively connected to the second surface of first race track section with one or more second hinges. In one embodiment, the one or more slide members each independently include one or more drawer slide members. In one embodiment, the one or more support members each independently include one or more chains, one or more ropes, one or more cables, or a combination thereof. In one embodiment, the race track trailer system further includes one or more radio-controllers that each independently control the one or more radio-controlled vehicles.

The present invention provides a race track trailer system for transporting and using a race track for use with one or more radio-controlled vehicles. The race track trailer system includes: a trailer having a first surface, a second surface, and a door having a first surface and a second surface, wherein the door is operatively connected to the trailer with one or more first hinges; a race track for use with one or more radio-controlled vehicles, wherein the race track includes: a first race track section having a first surface and a second surface having one or more first lanes, wherein the first surface of the first race track section is operatively connected to the first surface of the trailer; a second race track section having a first surface with one or more second lanes and a second surface, wherein the second race track section is operatively connected to the first race track section with one or more second hinges, a third race track section having a first surface and a second surface with one or more third lanes, wherein the first surface of the third race track section is operatively connected to one or more drawer slide members that are each independently operatively connected to the first surface of the door; one or more support members each independently having a proximal end operatively connected to the trailer and a distal end operatively connected to the door, wherein the one or more support members each independently include one or more cables, and when the race track is being used, the door of the trailer rotates from a closed position when the race track is being transported to an open position, the one or more slide members are each independently extended, and the one or more support members are each independently extended, wherein the second race track section rotates from the first race track section to be operatively connected with the third race track section when the door of the trailer is in an open position, the one or more slide members are each independently extended, and the one or more support members are each independently extended, and wherein the race track has a predetermined track layout forming a closed loop comprising the one or more first lanes, the one or more second lanes, and the one or more third lanes in which the one or more radio-controlled vehicles can travel on when the door of the trailer is an open position, the one or more slide members are each independently extended, the one or more support members are each independently extended, the second race track section is operatively connected to the third race track section, and wherein the closed loop is on the second surface of the first race track section, the first surface of the second race track section, and the second surface of the third race track section.

In one embodiment, the race track trailer system further includes one or more radio-controllers that each independently control the one or more radio-controlled vehicles.

The present invention provides a race track trailer system for transporting and using a race track for use with one or more radio-controlled vehicles. The race track trailer system includes: a trailer having a first surface, a second surface, and a door having a first surface and a second surface, wherein the door is operatively connected to the trailer; a race track for use with one or more radio-controlled vehicles, wherein the race track includes: a first race track section having a first surface and a second surface having one or more first lanes, wherein the first race track section is operatively connected to the first surface of the trailer; a second race track section having a first surface with one or more second lanes and a second surface, wherein the second race track section is operatively connected to the first race track section; a third race track section having a first surface and a second surface with one or more third lanes, wherein the third race track section is operatively connected to one or more slide members that are each independently operatively connected to the first surface of the door; and one or more support members each independently having a proximal end operatively connected to the trailer and a distal end each independently operatively connected to the door.

In one embodiment, the door of the trailer is in a closed position when the race track is being transported. In one embodiment, the door of the trailer is in an open position when the race track is being used. In one embodiment, the door of the trailer rotates from a closed position to an open position when the race track is being used. In one embodiment, the door of the trailer is in an open position, the one or more slide members are each independently extended, and the one or more support members are each independently extended when the race track is being used.

In one embodiment, the door is operatively connected to the trailer with one or more first hinges, one or more first support members, or a combination thereof. In one embodiment, the one or more slide members are each independently not extended when the race track is being transported. In one embodiment, the one or more slide members are each independently extended when the door of the trailer is in an open position when the race track is being used. In one embodiment, the one or more support members are each independently not extended when the race track is being transported. In one embodiment, the one or more support members are each independently extended when the door of the trailer is in an open position when the race track is being used.

In one embodiment, the second race track section rotates from the first race track section to be operatively connected with the third race track section when the door of the trailer is in an open position, the one or more slide members are each independently extended, and the one or more support members are each independently extended when the race track is being used.

In one embodiment, the race track has a predetermined track layout forming a closed loop including the one or more first lanes, the one or more second lanes, and the one or more third lanes in which the one or more radio-controlled vehicles can travel on when the door of the trailer is the open position, the one or more slide members are each independently extended, the one or more support members are each independently extended when the race track is being used, and the second race track section is operatively connected to the third race track section. In one embodiment, the closed loop is on the second surface of the first race track section, the first surface of the second race track section, and the second surface of the third race track section.

In one embodiment, the first surface of the first race track section is operatively connected to the first surface of the trailer. In one embodiment, the first surface of the first race track section includes one or more first folding legs that are folded during transport of the race track trailer system and extended when the race track is in use. In one embodiment, the second surface of the first race track section includes one or more first curved race track sections, one or more first straight race track sections, or a combination thereof. In one embodiment, the one or more first curved race track sections, one or more first straight race track sections, or the combination thereof each independently have one or more first angles of inclination.

In one embodiment, the second race track section is operatively connected to the first race track section with one or more second hinges. In one embodiment, the first surface of the second race track section is operatively connected to the second surface of first race track section. In one embodiment, the first surface of the second race track section is operatively connected to the second surface of first race track section with one or more second hinges.

In one embodiment, the second surface of the second race track section includes one or more second folding legs that are folded during transport of the race track trailer system and extended when the race track is in use. In one embodiment, the first surface of the second race track section includes one or more second curved race track sections, one or more second straight race track sections, or a combination thereof. In one embodiment, the one or more second curved race track sections, one or more second straight race track sections, or the combination thereof each independently have one or more second angles of inclination.

In one embodiment, the first surface of the third race track section is operatively connected to the first surface of the door. In one embodiment, the first surface of the third race track section includes one or more third folding legs that are folded during transport of the race track trailer system and extended when the race track is in use. In one embodiment, the second surface of the third race track section includes one or more third curved race track sections, one or more third straight race track sections, or a combination thereof. In one embodiment, the one or more third curved race track sections, one or more third straight race track sections, or the combination thereof each independently have one or more third angles of inclination.

In one embodiment, the one or more slide members each independently include one or more drawer slide members. In one embodiment, the one or more support members each independently include one or more chains, one or more ropes, one or more struts, one or more hangers, or a combination thereof.

In one embodiment, the second race track section and the third race track section are deployed under a first cover, which is operatively connected to a second cover.

In one embodiment, the race track trailer system further includes one or more radio-controllers that each independently control one or more radio-controlled vehicles. In one embodiment, the one or more radio-controlled vehicles are battery-powered. In one embodiment, the one or more radio-controlled vehicles are powered by a petroleum product. In one embodiment, the one or more radio-controlled vehicles are solar-powered. In one embodiment, the one or more radio-controllers are battery-powered. In one embodiment, the one or more radio-controllers are solar-powered.

The present invention provides a race track trailer system for transporting and using a race track for use with one or more radio-controlled vehicles. The race track trailer system includes: a trailer having a first surface, a second surface, and a door having a first surface and a second surface, wherein the door is operatively connected to the trailer; a race track for use with one or more radio-controlled vehicles, wherein the race track includes: a first race track section having a first surface and a second surface having one or more first lanes, wherein the first race track section is operatively connected to the first surface of the trailer; a second race track section having a first surface with one or more second lanes and a second surface, wherein the second race track section is operatively connected to the first race track section; a third race track section having a first surface and a second surface with one or more third lanes, wherein the third race track section is operatively connected to one or more slide members that are each independently operatively connected to the first surface of the door; one or more support members each independently having a proximal end operatively connected to the trailer and a distal end each independently operatively connected to the door, wherein the door of the trailer rotates from a closed position when the race track is being transported to an open position when the race track is being used, and wherein the second race track section rotates from the first race track section to be operatively connected with the third race track section when the door of the trailer is in an open position, the one or more slide members are each independently extended, and the one or more support members are each independently extended when the race track is being used.

In one embodiment, the door is operatively connected to the trailer with one or more first hinges, one or more first support members, or a combination thereof. In one embodiment, the race track has a predetermined track layout forming a closed loop including the one or more first lanes, the one or more second lanes, and the one or more third lanes in which the one or more radio-controlled vehicles can travel on when the door of the trailer is the open position, the one or more slide members are each independently extended, the one or more support members are each independently extended when the race track is being used, and the second race track section is operatively connected to the third race track section.

In one embodiment, the closed loop is on the second surface of the first race track section, the first surface of the second race track section, and the second surface of the third race track section. In one embodiment, the first surface of the first race track section is operatively connected to the first surface of the trailer. In one embodiment, the second race track section is operatively connected to the first race track section with one or more second hinges. In one embodiment, the first surface of the second race track section is operatively connected to the second surface of first race track section. In one embodiment, the first surface of the second race track section is operatively connected to the second surface of first race track section with one or more second hinges. In one embodiment, the one or more slide members each independently include one or more drawer slide members. In one embodiment, the one or more support members each independently include one or more chains, one or more ropes, one or more struts, one or more hangers, or a combination thereof. In one embodiment, the race track trailer system further includes one or more radio-controllers that each independently control the one or more radio-controlled vehicles.

The present invention provides a race track trailer system for transporting and using a race track for use with one or more radio-controlled vehicles. The race track trailer system includes: a trailer having a first surface, a second surface, and a door having a first surface and a second surface, wherein the door is operatively connected to the trailer with one or more first hinges; a race track for use with one or more radio-controlled vehicles, wherein the race track includes: a first race track section having a first surface and a second surface having one or more first lanes, wherein the first surface of the first race track section is operatively connected to the first surface of the trailer; a second race track section having a first surface with one or more second lanes and a second surface, wherein the second race track section is operatively connected to the first race track section with one or more second hinges, a third race track section having a first surface and a second surface with one or more third lanes, wherein the first surface of the third race track section is operatively connected to one or more drawer slide members that are each independently operatively connected to the first surface of the door; one or more support members each independently having a proximal end operatively connected to the trailer and a distal end operatively connected to the door, wherein the one or more support members each independently include one or more chains, one or more ropes, one or more cables, or a combination thereof, wherein the door of the trailer rotates from a closed position when the race track is being transported to an open position when the race track is being used, wherein the second race track section rotates from the first race track section to be operatively connected with the third race track section when the door of the trailer is in an open position, the one or more drawer slide members are each independently extended, and the one or more support members are each independently extended when the race track is being used, wherein the race track has a predetermined track layout forming a closed loop including the one or more first lanes, the one or more second lanes, and the one or more third lanes in which the one or more radio-controlled vehicles can travel on when the door of the trailer is the open position, the one or more drawer slide members are each independently extended, the one or more support members are each independently extended when the race track is being used, and the second race track section is operatively connected to the third race track section, and wherein the closed loop is on the second surface of the first race track section, the first surface of the second race track section, and the second surface of the third race track section.

In one embodiment, the race track trailer system further includes one or more radio-controllers that each independently control the one or more radio-controlled vehicles.

### BRIEF DESCRIPTION OF THE DRAWINGS

Embodiments of the invention may be best understood by referring to the following description and accompanying drawings, which illustrate such embodiments. In the drawings:

FIG. 1 is a front perspective view illustrating an exemplary race track trailer system in the closed position when the race track trailer system is being transported.

FIG. 2 is a front perspective view illustrating an exemplary race track trailer system in the open position when the race track trailer system is being used.

FIG. 3 is a side view drawing illustrating the interior of an exemplary race track trailer system in the closed position when the race track trailer system is being transported.

FIG. 4 is a side view drawing illustrating an exemplary race track trailer system in the open position when the race track trailer system is being deployed by the opening of the door.

FIG. 5 is a side view drawing illustrating an exemplary race track trailer system in the open position when the race track trailer system is being deployed by the opening of the door and sliding out of the one or more drawer slide members.

FIG. 6 is a side view drawing illustrating an exemplary race track trailer system in the open position when the race track trailer system is being deployed.

FIG. 7 is a side view drawing illustrating an exemplary race track trailer system in the open position when the race track trailer system is deployed.

FIG. 8 is a top view drawing illustrating an exemplary race track trailer system in the open position when the race track trailer system is deployed.

FIG. 9 is a side view drawing illustrating an exemplary race track trailer system in the open position when the race track trailer system is deployed under a cover.

The drawings are not necessarily to scale. Like numbers used in the figures refer to like components, steps, and the like. However, it will be understood that the use of a number to refer to a component in a given figure is not intended to limit the component in another figure labeled with the same number.

### DETAILED DESCRIPTION OF THE INVENTION

The present invention provides a race track trailer system for transporting and using a race track for use with one or more radio-controlled vehicles. The race track trailer system includes a trailer and a race track for use with one or more radio-controlled vehicles.

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense, and the scope of the present invention is defined by the appended claims and their equivalents.

Before the present invention is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the claims made herein.

Methods recited herein may be carried out in any order of the recited events which is logically possible, as well as the recited order of events. Furthermore, where a range of values is provided, it is understood that every intervening value, between the upper and lower limit of that range and any other stated or intervening value in that stated range is encompassed within the invention. Also, it is contemplated that any optional feature of the inventive variations described may be set forth and claimed independently, or in combination with any one or more of the features described herein.

The referenced items are provided solely for their disclosure prior to the filing date of the present application. Nothing herein is to be construed as an admission that the present invention is not entitled to antedate such material by virtue of prior invention.

Unless otherwise indicated, the words and phrases presented in this document have their ordinary meanings to one of skill in the art. Such ordinary meanings can be obtained by reference to their use in the art and by reference to general and scientific dictionaries, for example, Webster's Third New International Dictionary, Merriam-Webster Inc., Springfield, Mass., 1993 and The American Heritage Dictionary of the English Language, Houghton Mifflin, Boston Mass., 1981.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise. It is further noted that the claims may be drafted to exclude any optional element. As such, this statement is intended to serve as antecedent basis for use of such exclusive terminology as “solely,” “only,” and the like in connection with the recitation of claim elements, or use of a “negative” limitation.

As used herein, the term “comprising” or “comprises” is intended to mean that the compositions and methods include the recited elements, but not excluding others.

As used herein, the term “coupled” means the joining of two members directly or indirectly to one another. Such joining may be stationary in nature or movable in nature and/or such joining may allow for the flow of fluids, electricity, electrical signals, or other types of signals or communication between two members. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature.

As used herein, the phrase “operatively coupled” refers to bringing two or more items together or into relationship with each other such that they may operate together or allow transfer of information between the two or more items.

As used herein, the terms “include,” “for example,” “such as,” and the like are used illustratively and are not intended to limit the present invention.

As used herein, the terms “invention,” “the invention,” “this invention,” “the present invention” and “disclosure” are intended to refer broadly to all of the subject matter of this patent and the patent claims below. Statements containing these terms should be understood not to limit the subject matter described herein or to limit the meaning or scope of the patent claims below. The subject matter should be understood by reference to appropriate portions of the entire specification of this patent, any or all drawings and each claim.

As used herein, the terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, the term “proximal” refers to the closest end of an object. In contrast, the term “distal” refers to the farthest end of an object.

As used herein, the term “vehicle” refers to any motorized or other vehicle likely to travel at speed, for example, cars, motorbikes, off-road recreational vehicles, passenger vehicles, marine vehicles, for example, boats, industrial vehicles, for example, tractors and trucks, military vehicles, for examples, jeeps, tanks, half-tracks, and the like. The term also includes accessories, instrumentation and/or sensors carried by or inside the vehicle.

As used herein, the terms “front,” “back,” “rear,” “upper,” “lower,” “right,” and “left” in this description are merely used to identify the various elements as they are oriented in the FIGS, with “front,” “back,” and “rear” being relative apparatus. These terms are not meant to limit the element which they describe, as the various elements may be oriented differently in various applications.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

The invention illustratively disclosed herein suitably may be practiced in the absence of any element which is not specifically disclosed herein.

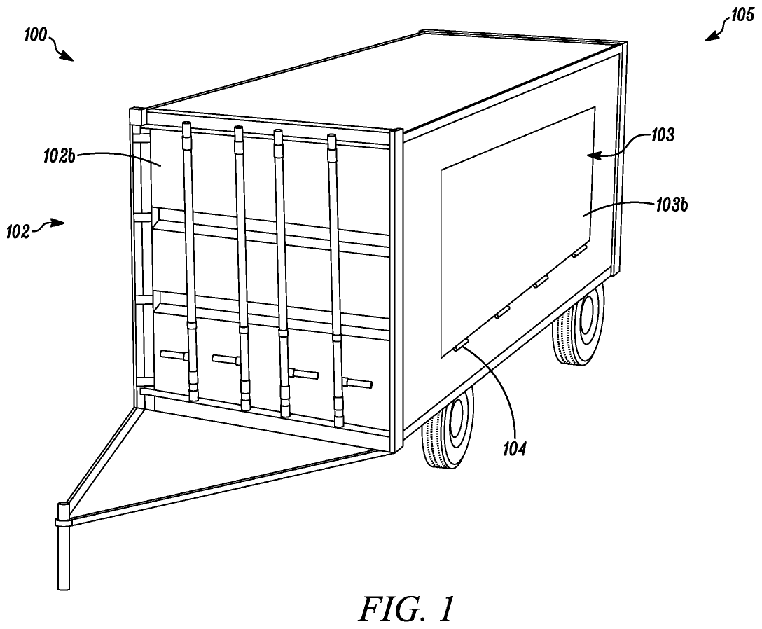

FIGS. 1-9 are various drawings illustrating an exemplary race track trailer system 100 for transporting and using a race track for use with one or more radio-controlled vehicles.

FIG. 1 is a front perspective view illustrating an exemplary race track trailer system 100 in the closed position when the race track trailer system 100 is being transported. The race track trailer system 100 includes a race track 101 (not shown) inside a trailer 102. The trailer 102 has a first surface 102a (not shown), a second surface 102b, and a door 103. The door 103 has a first surface 103a and a second surface 103b. The door 103 is operatively connected to the trailer 101 with one or more first hinges 104. The door 103 of the trailer 101 is in the closed position 105 when the race track trailer system 100 is being transported.

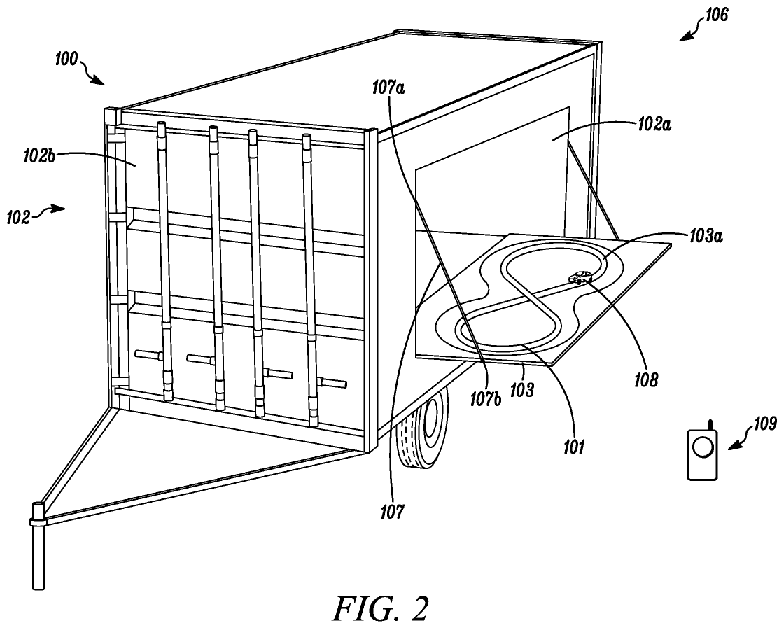

FIG. 2 is a front perspective view illustrating an exemplary race track trailer system 100 in the open position when the race track trailer system 100 is being used. The race track trailer system 100 includes: a race track 101 and a trailer 102. The trailer 102 has a first surface 102a, a second surface 102b, and a door 103. The door 103 has a first surface 103a and a second surface 103b. The door 103 is operatively connected to the trailer 102 with one or more first hinges 104. The door 103 of the trailer 101 is in the open position 106 when the race track trailer system 100 is being used. The one or more support members 107 each independently has a proximal end 107a operatively connected to the trailer 101 and a distal end 107b each independently operatively connected to the door 103. The race track 101 is fully deployed along with one or more radio-controlled vehicles 108 and one or more radio-controllers 109.

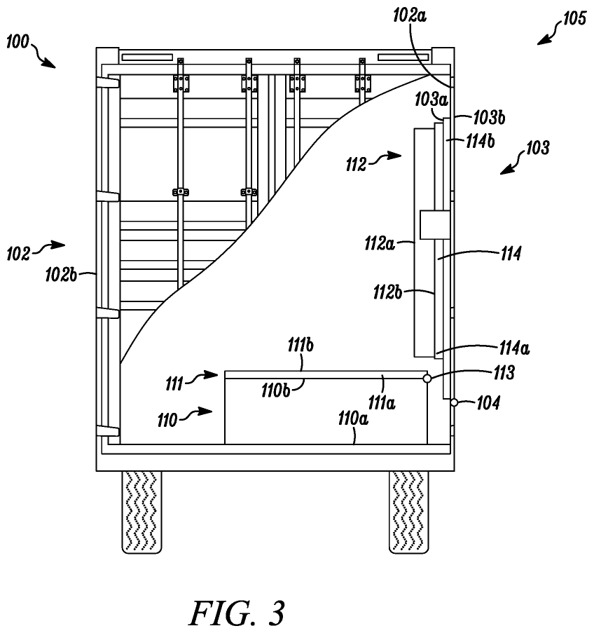

FIG. 3 is a side view drawing illustrating the interior of an exemplary race track trailer system 100 in the closed position 105 when the race track trailer system 100 is being transported. The race track trailer system 100 includes: a race track 101 and a trailer 102. The trailer 102 has a first surface 102a, a second surface 102b, and a door 103. The door 103 has a first surface 103a and a second surface 103b. The door 103 is operatively connected to the trailer 102 with one or more first hinges 104. The race track 101 includes: a first race track section 110, a second race track section 111, and a third race track section 112.

The first race track section 110 has a first surface 110a, a second surface 110b, one or more first lanes (not shown). The first surface 118 of the first race track section 110 is operatively connected to the first surface 102a of the trailer 102. The second race track section 111 has a first surface 111a with one or more second lanes (not shown) and a second surface 111b. The first surface of the second race track section 111a is operatively connected to the second surface of first race track section 110b with one or more second hinges 113. The third race track section 112 has a first surface 112a and a second surface 112b with one or more third lanes 112. The first surface 112a of the third race track section 112 is operatively connected to the one or more drawer slide members 114 that are each independently operatively connected to the first surface of the door 103a. The one or more support members 107 each independently has a proximal end 107a operatively connected to the trailer 102 and a distal end 107b each independently operatively connected to the door 103.

In one embodiment, the first surface 112a of the third race track section 112 is operatively connected to the first surface of the door 103a without using one or more drawer slide members 114.

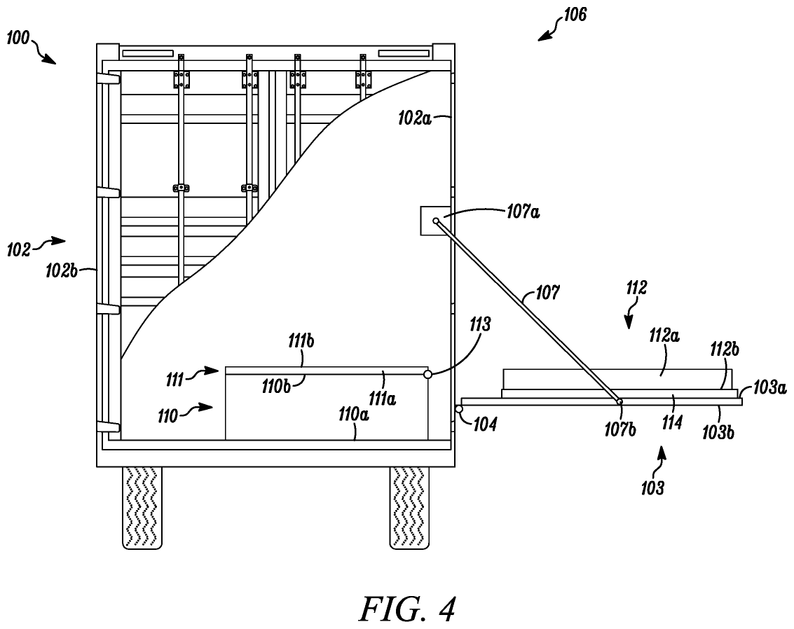

FIGS. 4-7 are side view drawings illustrating the deployment of the race track in an exemplary race track trailer system 100. The door 103 of the trailer 102 is in a closed position 105 when the race track 101 is being transported and in the open position 106 when the race track 101 is being used. To deploy the race track 101, the user (not shown) performs the following steps. First, the door 103 of the trailer 102 is rotated from a closed position 105 to an open position 106. Second, the one or more support members 107 are each independently extended to provide support for the door 103. Third, the one or more drawer slide members 114 are each independently extended along so that the third race track section 112 is extended outward beyond the door 103. Fourth, the second race track section 111 is rotated from the first race track section 110 to be operatively connected with the third race track section 112. Finally, the one or more radio-controlled vehicles 108 are placed on the race track 101 and the one or more radio-controllers 109 are distributed to the players (not shown).

FIG. 4 is a side view drawing illustrating an exemplary race track trailer system 100 in the open position 106 when the race track trailer system 100 is being deployed by the opening of the door 103. The race track trailer system 100 includes: a race track 101 and a trailer 102. The trailer 102 has a first surface 102a, a second surface 102b, and a door 103. The door 103 has a first surface 103a and a second surface 103b. The door 103 is operatively connected to the trailer 102 with one or more first hinges 104. The race track 101 includes: a first race track section 110, a second race track section 111, and a third race track section 112.

The first race track section 110 has a first surface 110a, a second surface 110b, one or more first lanes (not shown). The first surface 110a of the first race track section 110 is operatively connected to the first surface 102a of the trailer 102. The second race track section 111 has a first surface 111a with one or more second lanes (not shown) and a second surface 111b. The first surface of the second race track section 111a is operatively connected to the second surface of first race track section 110b with one or more second hinges 113. The third race track section 112 has a first surface 112a and a second surface 112b with one or more third lanes 112. The first surface 112a of the third race track section 112 is operatively connected to the one or more drawer slide members 114 that are each independently operatively connected to the first surface of the door 103a. The one or more support members 107 each independently has a proximal end 107a operatively connected to the trailer 102 and a distal end 107b each independently operatively connected to the door 103.

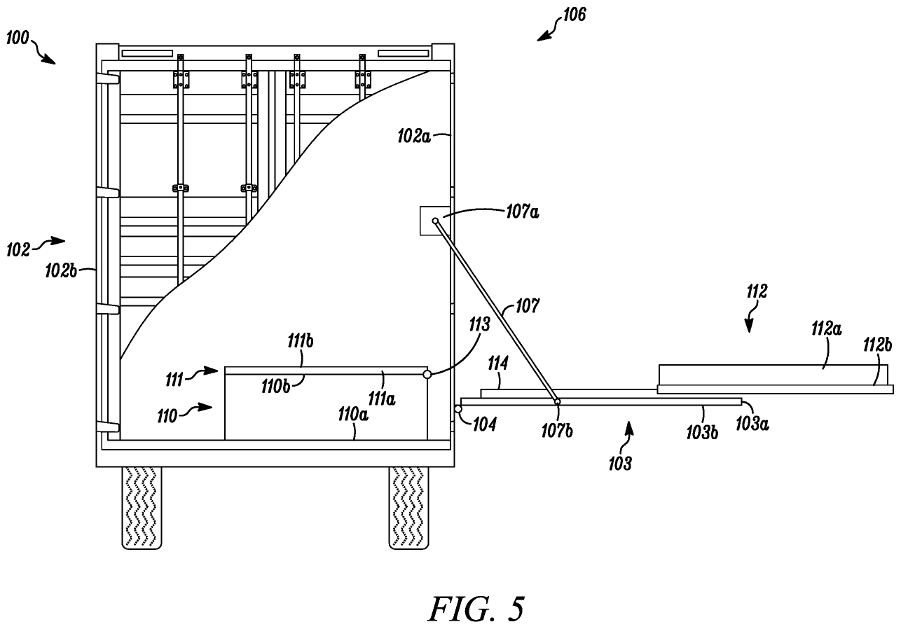

FIG. 5 is a side view drawing illustrating an exemplary race track trailer system 100 in the open position 106 when the race track trailer system 100 is being deployed by the opening of the door 103 and sliding out of the one or more drawer slide members 114.

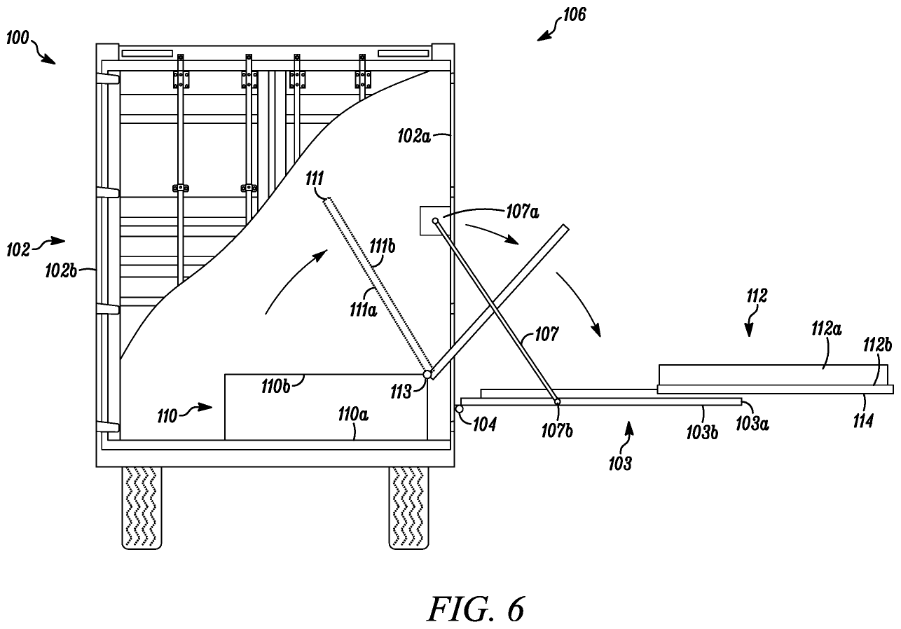

FIG. 6 is a side view drawing illustrating an exemplary race track trailer system 100 in the open position 106 when the race track trailer system 100 is being deployed by the opening of the door 103, sliding out of the one or more drawer slide members 114, and rotating the second race track section 111 from the first race track section 110 to the third race track section 112.

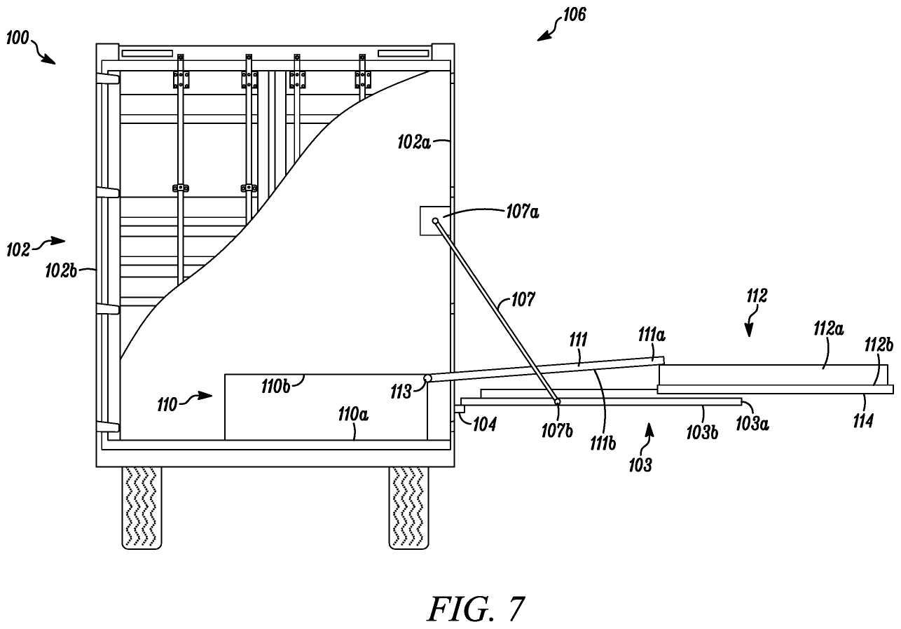

FIG. 7 is a side view drawing illustrating an exemplary race track trailer system 100 in the open position 106 when the race track trailer system 100 is deployed with the first race track section 110 operatively connected to the second race track section 111 which is operatively connected to the third race track section 112.

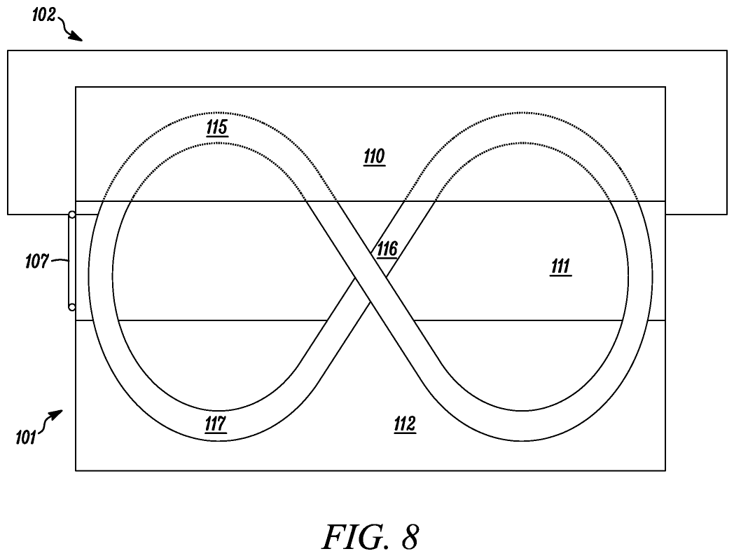

FIG. 8 is a top view drawing illustrating an exemplary race track trailer system 100 in the open position 106 when the race track trailer system 100 is deployed with the first race track section 110 operatively connected to the second race track section 111 which is operatively connected to the third race track section 112. The race track 101 has a predetermined track layout forming a closed loop includes the one or more first lanes 115, the one or more second lanes 116, and the one or more third lanes 117 in which the one or more radio-controlled vehicles 108 can travel on when the door 103 of the trailer 102 is the open position 106.

In one embodiment, the one or more first lanes 115 are on the second surface of the first race track section 106, the one or more second lanes 116 are on the first surface of the second race track section 107, and the one or more third lanes 117 are on the second surface of the third race track section 108.

In one embodiment, the one or more support members 107 each independently include one or more chains 118, one or more ropes 119, one or more struts 120, one or more hangers 121, one or more cables 124, or a combination thereof.

In one embodiment, the one or more first lanes 115, the one or more second lanes 116, and the one or more third lanes 117 include one or more road sections. In one embodiment, the one or more first lanes 115, the one or more second lanes 116, and the one or more third lanes 117 include one or more off-road sections. In one embodiment, the one or more first lanes 115, the one or more second lanes 116, and the one or more third lanes 117 include the combination of one or more road sections and one or more off-road sections.

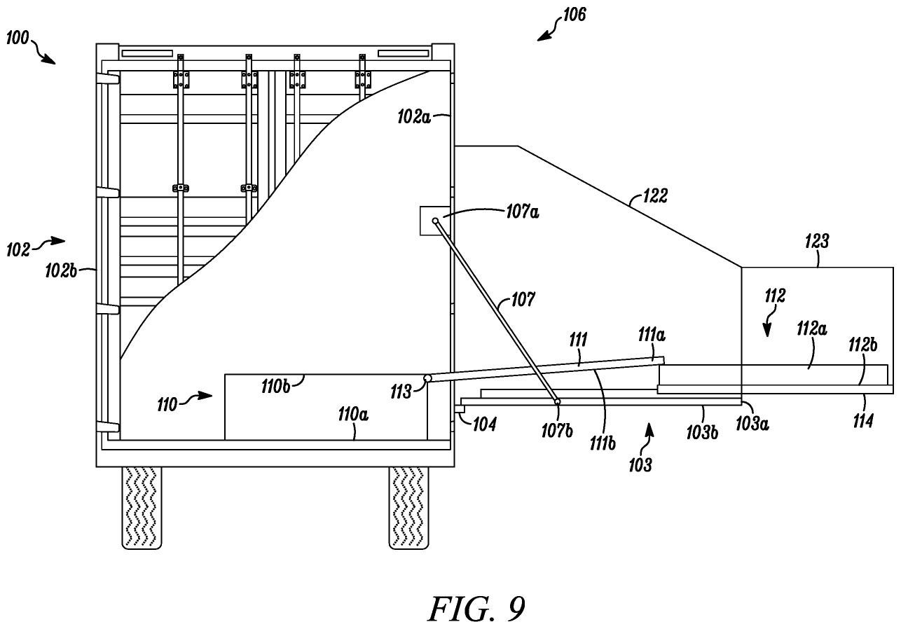

FIG. 9 is a side view drawing illustrating an exemplary race track trailer system 100 in the open position 106 when the race track trailer system 100 is deployed with the first race track section 110 operatively connected to the second race track section 111 which is operatively connected to the third race track section 112. The second race track section 111 and the third race track section 112 are deployed under a first cover 122 and a second cover 123.

Although the above description relates to a race track trailer system with one door and with one race track configuration, the present invention also encompasses race track trailer systems that have more than one door and more than one race track configuration.

In the claims provided herein, the steps specified to be taken in a claimed method or process may be carried out in any order without departing from the principles of the invention, except when a temporal or operational sequence is explicitly defined by claim language. Recitation in a claim to the effect that first a step is performed then several other steps are performed shall be taken to mean that the first step is performed before any of the other steps, but the other steps may be performed in any sequence unless a sequence is further specified within the other steps. For example, claim elements that recite “first A, then B, C, and D, and lastly E” shall be construed to mean step A must be first, step E must be last, but steps B, C, and D may be carried out in any sequence between steps A and E and the process of that sequence will still fall within the four corners of the claim.

Furthermore, in the claims provided herein, specified steps may be carried out concurrently unless explicit claim language requires that they be carried out separately or as parts of different processing operations. For example, a claimed step of doing X and a claimed step of doing Y may be conducted simultaneously within a single operation, and the resulting process will be covered by the claim. Thus, a step of doing X, a step of doing Y, and a step of doing Z may be conducted simultaneously within a single process step, or in two separate process steps, or in three separate process steps, and that process will still fall within the four corners of a claim that recites those three steps.

Similarly, except as explicitly required by claim language, a single substance or component may meet more than a single functional requirement, provided that the single substance or component fulfills the more than one functional requirement as specified by claim language.

All patents, patent applications, publications, scientific articles, web sites, and other documents and materials referenced or mentioned herein are indicative of the levels of skill of those skilled in the art to which the invention pertains, and each such referenced document and material is hereby incorporated by reference to the same extent as if it had been incorporated by reference in its entirety individually or set forth herein in its entirety. Additionally, all claims in this application, and all priority applications, including but not limited to original claims, are hereby incorporated in their entirety into, and form a part of, the written description of the invention.

Applicant reserves the right to physically incorporate into this specification any and all materials and information from any such patents, applications, publications, scientific articles, web sites, electronically available information, and other referenced materials or documents. Applicant reserves the right to physically incorporate into any part of this document, including any part of the written description, the claims referred to above including but not limited to any original claims.

What is claimed is:

1. A race track trailer system for transporting and using a race track for use with one or more radio-controlled vehicles comprising:
a trailer having a first surface, a second surface, and a door having a first surface and a second surface,
wherein the door is operatively connected to the trailer;
a race track for use with one or more radio-controlled vehicles, wherein the race track comprises:
a first race track section having a first surface and a second surface having one or more first lanes,
wherein the first race track section is operatively connected to the first surface of the trailer;
a second race track section having a first surface with one or more second lanes and a second surface,
wherein the second race track section is operatively connected to the first race track section;
a third race track section having a first surface and a second surface with one or more third lanes,
wherein the third race track section is operatively connected to the first surface of the door;
one or more support members each independently having a proximal end operatively connected to the trailer and a distal end each independently operatively connected to the door, and
when the race track is being used, the door of the trailer rotates from a closed position when the race track is being transported to an open position, and the one or more support members are each independently extended.

2. The race track trailer system of claim 1, wherein the door is operatively connected to the trailer with one or more first hinges, one or more first support members, or a combination thereof.

3. The race track trailer system of claim 1, wherein the second race track section rotates from the first race track section to be operatively connected with the third race track section when the door of the trailer is in an open position and the one or more support members are each independently extended.

4. The race track trailer system of claim 1, wherein the race track has a predetermined track layout forming a closed loop comprising the one or more first lanes, the one or more second lanes, and the one or more third lanes in which the one or more radio-controlled vehicles can travel on when the door of the trailer is an open position, the one or more support members are each independently extended, the second race track section is operatively connected to the third race track section, and wherein the closed loop is on the second surface of the first race track section, the first surface of the second race track section, and the second surface of the third race track section.

5. The race track trailer system of claim 1, wherein the first surface of the first race track section is operatively connected to the first surface of the trailer.

6. The race track trailer system of claim 1, wherein the first surface of the second race track section is operatively connected to the second surface of first race track section with one or more second hinges.

7. The race track trailer system of claim 1, wherein the one or more support members each independently comprise one or more chains, one or more ropes, one or more cables, or a combination thereof.

8. The race track trailer system of claim 1, further comprising one or more radio-controllers that each independently control the one or more radio-controlled vehicles.

9. A race track trailer system for transporting and using a race track for use with one or more radio-controlled vehicles comprising:
a trailer having a first surface, a second surface, and a door having a first surface and a second surface,
wherein the door is operatively connected to the trailer;
a race track for use with one or more radio-controlled vehicles, wherein the race track comprises:
a first race track section having a first surface and a second surface having one or more first lanes,
wherein the first race track section is operatively connected to the first surface of the trailer;
a second race track section having a first surface with one or more second lanes and a second surface,
wherein the second race track section is operatively connected to the first race track section;
a third race track section having a first surface and a second surface with one or more third lanes,
wherein the third race track section is operatively connected to one or more slide members that are each independently operatively connected to the first surface of the door;
one or more support members each independently having a proximal end operatively connected to the trailer and a distal end each independently operatively connected to the door,
when the race track is being used, the door of the trailer rotates from a closed position when the race track is being transported to an open position, the one or more slide members are each independently extended, and the one or more support members are each independently extended, and
wherein the door is operatively connected to the trailer with one or more first hinges, one or more first support members, or a combination thereof.

10. The race track trailer system of claim 9, wherein the second race track section rotates from the first race track section to be operatively connected with the third race track section when the door of the trailer is in an open position, the one or more slide members are each independently extended, and the one or more support members are each independently extended.

11. The race track trailer system of claim 9, wherein the race track has a predetermined track layout forming a closed loop comprising the one or more first lanes, the one or more second lanes, and the one or more third lanes in which the one or more radio-controlled vehicles can travel on when the door of the trailer is an open position, the one or more slide members are each independently extended, the one or more support members are each independently extended, the second race track section is operatively connected to the third race track section, and wherein the closed loop is on the second surface of the first race track section, the first surface of the second race track section, and the second surface of the third race track section.

12. The race track trailer system of claim 9, wherein the first surface of the first race track section is operatively connected to the first surface of the trailer.

13. The race track trailer system of claim 9, wherein the first surface of the second race track section is operatively connected to the second surface of first race track section with one or more second hinges.

14. The race track trailer system of claim 9, wherein the one or more slide members each independently comprise one or more drawer slide members.

15. The race track trailer system of claim 9, wherein the one or more support members each independently comprise one or more chains, one or more ropes, one or more cables, or a combination thereof.

16. The race track trailer system of claim 9, further comprising one or more radio-controllers that each independently control the one or more radio-controlled vehicles.

17. A race track trailer system for transporting and using a race track for use with one or more radio-controlled vehicles comprising:
a trailer having a first surface, a second surface, and a door having a first surface and a second surface,
wherein the door is operatively connected to the trailer with one or more first hinges;
a race track for use with one or more radio-controlled vehicles, wherein the race track comprises:
a first race track section having a first surface and a second surface having one or more first lanes,
wherein the first surface of the first race track section is operatively connected to the first surface of the trailer;
a second race track section having a first surface with one or more second lanes and a second surface,
wherein the second race track section is operatively connected to the first race track section with one or more second hinges,
a third race track section having a first surface and a second surface with one or more third lanes,
wherein the first surface of the third race track section is operatively connected to one or more drawer slide members that are each independently operatively connected to the first surface of the door;
one or more support members each independently having a proximal end operatively connected to the trailer and a distal end operatively connected to the door,
wherein the one or more support members each independently comprise one or more cables, and
when the race track is being used, the door of the trailer rotates from a closed position when the race track is being transported to an open position, the one or more slide members are each independently extended, and the one or more support members are each independently extended,
wherein the second race track section rotates from the first race track section to be operatively connected with the third race track section when the door of the trailer is in an open position, the one or more slide members are each independently extended, and the one or more support members are each independently extended, and wherein the race track has a predetermined track layout forming a closed loop comprising the one or more first lanes, the one or more second lanes, and the one or more third lanes in which the one or more radio-controlled vehicles can travel on when the door of the trailer is an open position, the one or more slide members are each independently extended, the one or more support members are each independently extended, the second race track section is operatively connected to the third race track section, and wherein the closed loop is on the second surface of the first race track section, the first surface of the second race track section, and the second surface of the third race track section.

18. The race track trailer system of claim 17, further comprising one or more radio-controllers that each independently control the one or more radio-controlled vehicles.
